(19) United States
(12) Patent Application Publication
(10) Pub. No.: US 2015/0213531 A1
(43) Pub. Date: Jul. 30, 2015

(54) Computer-Assisted Interactive Reverse Auctions

(71) Applicant: William K. Kung, New York, NY (US)

(72) Inventor: William K. Kung, New York, NY (US)

(21) Appl. No.: 14/163,445

(22) Filed: Jan. 24, 2014

(51) Int. Cl. G06Q 30/06

(52) U.S. Cl. CPC G06Q 30/0611

(57) ABSTRACT

The present invention comprises a system and a method of competitive reverse auctioning that drops the price of a good in predetermined increments over pre-determined time intervals until it is sold. The first buyer to click the hammer to purchase will stop this reverse auction process. In theory the person who first bids the “cheapest dropping price” wins the auction.

### BACKGROUND

1. Field of Use

This invention relates to a reverse auction process and more particularly to an online automated auction which provides participation amongst multiple parties in an open and highly interactive environment.

Web-based auctions have proliferated in popularity alongside the growth of the Internet. Reverse auctions are an alternative format to traditional ascending price auctions. In a traditional reverse auction, multiple sellers react to a buyer's offer to buy good(s) and/or service(s). Once a starting bid has been established, participating sellers could offer to sell the sought after goods or services at amounts lower than the current bid. The downward bidding process continues for a set period of time, and the seller with the lowest bid would be considered the winner. In most cases, the buyer must accept the good(s) and/or service(s) of the lowest-bid seller. In other cases, the buyer has the discretion to select any bidder from the pool of participating sellers. Compared to traditional auctions, reverse auctions facilitate downward bidding among multiple sellers in an attempt to create market conditions that are favorable to the buyer. The auctioneer may set the starting amount.

Unlike these traditional reverse auctions, in the reverse auction of the present invention, a single seller repeatedly lowers the offer price for an auctioned item, such as a precious gem, while multiple buyers are able to decide when and whether to accept the offer. This novel form of reverse auction creates value both to the seller who is better able to control the final selling puce for the auctioned item, and to buyers, who are able to choose when to accept an offer that suits them by weighing the knowledge that the price of the auctioned item may continue to drop in a sequential manner over time, the goods may be taken by other buyers, or the price may hit a reserve price and be withdrawn. This system eliminates the inefficiencies of both the traditional ascending price auctions in which the reserve price may not be reached or buyers may engage in a spiral of overbidding, and the traditional reserve auctions in which sellers may underbid their goods or services in an attempt to make a sale. The system instead creates a strategic game element to the auction process, which benefits both sellers and buyers and results in a more efficient and equitable system of distribution.

2. The Related Prior Art

U.S. Pat. No. 8,548,895 relates to an auction system where one or more proxy bidders are associated with a rule which determines a time to place a bid. The proxy bidder places a bid at the determined time, instead of immediately after the bidders prior bid is exceeded. Such rules may be selected for all proxy bidders to encourage a desired auction behavior. By controlling the placement of bids based on rules associated with the desired auction behavior, bids may be placed in a manner that seems natural and competitive to bidders in the auction when, in fact, they are placed in accordance with the selected rules. The desired auction behavior may be selected statically for an auction or dynamically during the auction. Historical auction data may be analyzed to characterize the behavior of an auction, such as the average period of time between bids and the average increment between bids. Rules may be generated to correspond to a behavior so as to provide the same average time and increment between bids.

U.S. Pat. No. 8,335,746 relates to a transaction bargaining method. The method involves testing pairs of non-equal values, submitted by two opposite parties to a transaction, for satisfaction of a condition. If the condition is not satisfied, the method further involves testing a pair of non-equal power round values, one from each of the two opposite parties for the transaction, for satisfaction of a power round condition. The method further involves calculating a binding bargained payment, when the condition is satisfied by a pair of the non-equal values. The binding bargained payment is an amount at least equal to a lower of the pair of the non-equal values.

U.S. Pat. No. 8,036,949 relates to a method for real-time, interactive, competitive, live online auctioning using an animated auctioneer. The animated auctioneer initiates the auction, actively solicits bids from the auction participants, acknowledges bids input from auction participants, and moves to close the auction when there is a cessation in bidding. In the course of the auction, the auctioneer audibly and physically promotes the item up for bid, and entices the participants to bid. Participants input bids in real-time, competitively and successively in response to the animated auctioneer's solicitations.

PCT Application No. PCT/US2012/060012 discloses a computer-implemented method for facilitating the sale of an item between a buyer and at least one seller. Information on a good or a service is received from a buyer. The buyer designates the flexibility of the buyer and information from a social network. The information on the good or service is broadcast to at least one seller. Without the seller knowing how much the buyer is willing to spend, the identity of the buyer, identities of competing sellers, and how much other sellers are offering for the item, the seller makes an offer. A relative-fidelity score is assessed and a relative-price score is determined. Information from the social network is analyzed with respect to the buyer and the seller, and the results are communicated to the buyer.

The array of limitations of the prior art described above result in inefficiencies and biases that destabilize market conditions and values that tend to disfavor both buyers and sellers. What is desired are systems, processes, and methodologies that provide optimal objectivity in the market place and produce reliable outcomes that enhance the buyer-seller relationship, yielding efficiency in conducting a buyer initiated reverse auction.

### SUMMARY

The present invention is a system and method of competitive reverse auctioning that drops the price of a good in pre-determined increments until it is sold or withdrawn. The first buyer to click the hammer to purchase will stop this reverse auction process. In theory the person who first bids the “cheapest dropping price” wins the auction. The invention is particularly well-suited to auctions for diamonds and other luxury goods, although it may also be used for other types of goods and services.

It is an object of this invention to provide a computer executable system and method for auctions, operative to control a computer and stored on at least one computer readable medium. The systems and methods when executed via a processor comprise: a) offering an item for auction, such as a precious gem, at a opening price to a plurality of parties; b) maintaining the opening price offer for a pre-determined period of time; c) lowering the offer price for the auction item if no party to the auction has accepted the offer at the opening price after a pre-determined period of time either a pre-determined amount or a pre-determined percentage; d) maintaining the new price offer for another pre-determined period of time; e) lowering the new offer price for the auction item if no party to the auction has accepted the offer at the new offer price in a similar manner to (c); f) repeating the cycle of offering a new price for a period of time before lowering the price if no party accepts the offer at that price; and g) halting the auction when a party to the auction accepts the offer price or when the price level reaches a reserve price below which the auction item will not be sold. The changes in price level can be set by the system, by the administrator, or by the seller, or can be made dependent upon auction activity, such as the number of parties participating in the auction. Still further provided is the method wherein the time for which an item is offered at a particular price may be set by the system, by the administrator, or by the seller, or can be made dependent upon auction activity, such as the number of parties participating in the auction. The method may further comprise limiting the number of changes to the price level of the offer, the size of each price change, the starting price or the reserve price.

Another object of the invention is to provide an auction system and method comprising making an offer to multiple parties to an auction with respect to an auctioned item, such as a precious gem, and receiving acceptance of the offer from one of the parties to the auction, where acceptance of the offer is received via a password protected communication linkage and the acceptance is automatically reported to all parties to the auction, thereby ending the auction for that particular auctioned item. Further provided is the system and method wherein, when no offer is accented, the system and method further comprises withdrawing the auction item once the offered price level has fallen to a chosen reserve price.

### BRIEF DESCRIPTION OF THE DRAWINGS

The above and other objects and advantages of the invention will be apparent upon consideration of the following detailed description, taken in conjunction with the accompanying figures, in which like reference characters refer to like parts throughout, and in winch:

FIG. 1 shows how a party involved in a transaction might use the confidential and fully automated system;

FIG. 2 shows the method flow chart for the auction process.

### DETAILED DESCRIPTION OF THE PREFERRED EMBODIMENTS

The present invention is described below with reference to the illustrative diagrams in accordance with the invention. However, the invention is not limited to the described embodiment and a person skilled in the art will appreciate that many other embodiments of the invention are possible without deviating horn the basic concept of the invention, and that any such work around will also fall under the scope of this invention. It is envisioned that other styles and configurations of the present invention can be easily incorporated into the teachings of the present invention, and only certain particular configurations are shown and described for purposes of clarity and disclosure and not by way of limitation of scope. The definitions provided herein provide descriptive guidance to one of ordinary skill, but do not place limitations upon the reasonable scope of the meaning of claim terms.

It is understood that the systems and methods described in each of the diagrams may be implemented by means of analog or digital hardware and computer program instructions. These computer program instructions may be provided to a processor of a general purpose computer, a special purpose computer, or other programmable data processing apparatus, such that the instructions, which execute via the processor of a computer or other programmable data processing apparatus, implement the functions/acts specified in the diagrams and text of this application.

Headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). The terms “a” and “an” herein do not denote a limitation of quantity, but rather denote the presence of at least one of the referenced items.

The invention comprises a computerized system for automated auctions that may be conducted online, for example through an Internet website. Users may interact with the system via the Internet or other communications linkages. The system includes providing a sequential series of offers declining in price level over time to conclude an auction transaction.

An “offer” is the amount of money (or equivalent value) required by the person owning or controlling an item to be auctioned tor which the person would be willing to reach agreement. Information corresponding to the amount of the otter is entered by the person owning the item to be auctioned, or his or her representative, by using the numbers of a touch-tone or cellular telephone or the keyboard of a personal computer.

The party to the auction (for example a buyer or sponsor) accesses the system via the Internet using any standard web browser or via an ordinary touch-tone or cellular telephone. The system “prompts” the user at each step of the process and provides automated help if needed. Unlike a traditional ascending price auction, the reverse auction process lowers the price for sale of an item in pre-determined increments over time. The period of time for which each sales price is maintained may be varied. The change in price (the incremental price drop) may also be varied. As well as pre-selecting fixed periods of time or fixed levels of price changes the administrator may enable the system to shorten the length of time between price changes or the size of the change in sales price level based on auction parameters, such as the number of viewers, the number of bidders or the frequency of bidding or based on other pre-determined criteria. For example, an auction may be advertised on the website home page for an item, such as a diamond, to be offered at an opening price of $500,000. Interested buyers may then log in to the website and access the auction page. The auction page will show the details of the diamond and a price “ticker” winch will be primed to countdown at certain intervals. The “ticker” may show when the next price change will occur or may keep the buyers guessing as to the intervals according to the preference of the auction administrators. Buyers will have a clickable icon on their individual auction page which will enable either one-click acceptance of the current offer or acceptance after being prompted to enter in a confirmation code to verify that acceptance of an offer has been intended (this will however necessarily mean a risk that the buyer will be beaten to acquisition of the diamond by a faster competitor). In this scenario, after two hours at $500,000 the price of the diamond is lowered to $475,000. This price level is maintained for another two hours before being lowered to $450,000. The website will display the current status of any ongoing auctions to users and they may have the ability to set up notifications regarding certain sale price points for diamonds. If the $450,000 sales price creates interest more buyers may start to log in and join the auction. The price level may continue to be adjusted every two hours, but may also be set to speed up if there are more than, for example, fifty potential buyers viewing the auction. This will create excitement and game strategy as the more viewers of an auction, the faster a price may drop, but also the risk to any one buyer that another buyer will jump in with an acceptance of the current offer. For example, after only one hour the price for the diamond may be dropped to $425,000, and if more buyers join the auction, after only half an hour the price may drop to $400,000. At this point, interested buyers must begin to decide whether they dare to wait and see if the price will drop further or whether they risk losing the diamond to a competitor. The auction administrator or the seller can also set a reserve price below which the price level will not drop. This reserve price may or may not be displayed on the auction page of the website. If displayed, buyers will be aware of the end point for the auction if desired. In the foregoing scenario, the diamond will not sell for less than $350,000. Therefore, when the price drops after another half hour to $375,000 many buyers may be tempted to buy at that point as once the $350,000 price level is reached the action may expire. To further enhance excitement, the auction administrator may also choose to have the decrease in price level become shorter as the reserve price is approached. Thus, after half an hour the price may drop to $370,000, then to $365,000 and so on. This makes succeeding in the reverse auction a test of a buyer's nerve and judgment with high rewards for the most skilled buyers. The acceptance of offers occurs on a “first come, first served” basis, which also creates excitement as buyers must pay attention to price changes to ensure that they are not “beaten to the punch” by rivals.

The system may be designed to restrict auction access to registered users, or to admit non-registered users to view and monitor auctions in progress. The system may be administered and utilized by the owner of items for sale, such as diamonds, to sell those items with all the attendant arrangements for completion of a sale being taken care of by the system administrator independently. In certain countries, final completion of a sale may require a physical inspection of the item before the purchase is complete and the final monetary exchange may be a cash transaction at the point of physical inspection. In other countries, the sale of an item may be completed virtually instantaneously via an online credit card transaction with physical delivery of the item to the buyer taken care of by standard online shipping means or other standard methods of delivery.

The system preferably is designed to allow a user to communicate with the system through a variation of electronic devices, such as a PC computer via the Internet or other wired, wireless, mobile, and satellite communication technologies. Devices such as electronic tablets, mobile devices and other cellular devices and the like are all supported. The communication linkage may be an internet connection, a LAN or WAN connection, a WiFi connection, a voice connection, a wired or wireless telephone connection, or a satellite connection. Preferably, the system is capable of generating voice messages to a person communicating with the system through a touch tone or a cellular phone linkage to guide the person in the use of the system. Alternatively, written messages may be used as prompts when the system is accessed horn a personal computer via the Internet.

Upon the successful conclusion of the auction, a contract is concluded between seller and buyer with automatic payment being made. The system maintains records of all such transactions and informs the seller whenever a sale has been made. The online nature of the system provides the ability to automatically provide immediate payment to a seller or initiate an immediate transfer of the payment or value when an agreement is reached. The system includes an interface to effectuate payment to the seller automatically, For example, the interface may be to a payment card account system such that if an agreement is reached, and the seller is a registered cardholder, the sellers credit/debit/charge/entertainment card is automatically credited with the agreement amount. Similarly, if the seller has a smart card, stored value card, online creditable purse or module, online payment account such as PayPal, or other on-line accessible way for the recipient to automatically (and preferably directly) receive the transfer, the system may be configured to automatically credit it with the agreement amount. Given the numerous ways known to transfer or receive value online and the rate of growth in new ways to do so, it will be appreciated that the basic principle is the automatic provision or transfer of value, not the particular scrip, protocol or device used to do so. In some instances, the interface is merely a pre-configured vehicle for communicating with an authority in order to inform the authority that a transfer is to be made. In this manner suitable arrangements may be made so that the system can convert the agreement into a non-monetary payment-in-kind or transfer. For example, through an arrangement with an airline frequent flyer program, or other program offering “points”, the agreement can be converted into the appropriate amount of miles or points. Alternatively, the agreement may involve a non-monetary agreement figure which can automatically initiate a transfer of stocks, bonds, commodities, precious metals, gems, etc., lodged with an escrow agent. In the event of an agreement, the appropriate amount is calculated as the agreement figure and automatically transferred to the seller. For example, in the transaction of stocks, the shares will be automatically registered in the name of the seller, it will be recognized that, consistent with the description herein, automated bargaining would be extensible to apply to other payment-in-kind situations in a straightforward manner. Depending upon the particular implementation, a currency converter is also included. This allows auction participants to use different currencies, for example, U.S. dollars. Euros, Pounds, Lira, or Yen, without having to take into account the current exchange rate or accept offers using an unfamiliar currency. When offers or acceptances are entered in such a system, the system automatically converts the offer and acceptance into a common currency. Typically, this will be the currency specified by the selling party. Alternatively, the currency used can be based upon a selection by the seller or the parties to the auction. For example, a Japanese party and Canadian party could select the Euro as the basic currency of the auction. The computer performs its functions and the results are reported to the parties as they occur in real time without waiting.

Data related to the auctions is stored by the system. It may be used by the system host for various purposes, such as data analytics regarding regional location of buyers, optimal times for auctions to be held, etc. The data may also be analyzed to adjust pricing schemes for auctions and to improve the underlying auction algorithms. The system further includes a processor accessible storage configured to both permanently and temporarily store values related to the auction process, and buyer and seller transaction histories.

Data regarding pricing of items or other historical data relevant to the auction process may be made available to users on a fee basis or for free if so desired. The system also includes a searchable database which includes data relating to auctioned transactions. The data can include geographic information for each auction transaction, the monetary amount for each auction transaction. The system further includes a communication link over which the searchable database can be accessed by an entity prior to opening a series of offers on the auction system.

Security is preferably included to make the system inaccessible without entry of the proper information, for example, an auction identification number identifying the auction, a security code corresponding to the auction, and a user security code corresponding to the auction and identifying the user, the user being the person or representative thereof who is viewing the auction. Preferably, the processor and system conducting the auction has a “firewall” or protective barrier against unauthorized traffic, and uses encryption technology, and each transaction concluding an auction is preferably password protected to assure privacy and prevent unauthorized access. For example, the system may require a user to enter a password or user identification number or alphanumeric combination and a user authorization code providing access control to the system. For increased security, systems may be designed which require user authentication, for example through the use of voice pattern, fingerprints, physical signature, “smart” card, or email or text message code authorization. Advantageously, if the smart card is used, certain embodiments will allow an agreement to be completed by direct transfer of funds onto the party's smart card. In an Internet-based embodiment of the present invention, an Internet website is set up to provide the interface between system and user. Preferably, the major areas of the website include a login area for parties or agents for parties to auctions, and a login area for administration personnel who oversee the system. If desired, the website may also include a publicly accessible area that highlights information about the system. For increased security, a separate website may be set up with this information.

The administrator has the power to adjust the way the system performs based upon auction metrics reflecting the number and frequency of users participating in auctions. An administrator acting on behalf of the auction host will set auction parameters, including starting price, reserve price, adjustment in the size of price increments, the timing of adjustments (which may be set according to the seller's received instructions), the speed or size of adjustments in price dependent on the number of participants to the auction, etc.

The general user interface will enable the use of hot buttons by the user to perform actions such as closing an auction deal. The user interface may also allow the display of trends in the auctions to users, enable access to bulletin boards or other forms of social media, private messaging and advertising. The website may include social networking functions, user forums and other interactive services, as well as providing access to the auctions. The user may log out of the system from a menu choice to end the session and return the user to the login screen. If a user attempts to engage the system again, he or she will have to login their user name/password pair. Preferably, logging out clears the password, but not the user name, so that upon subsequent login the computerized system may check for the user's name in the user's cookie if the user accesses the system with the same computer. The screens appearing in the operation of the system may be created by suitable computer programs commonly known in the art. Preferably, if a period of time passes without activity when a user is online, for example 20 minutes under normal network traffic conditions, the user is automatically logged out tor security precautions. For all or a portion of the data, the system may be designed so that once data has been entered, a sponsor or other user has a period of time, for example 30 minutes, during which it can be modified or withdrawn but after which the data cannot be withdrawn.

The administrators of the auction site use a central computer processing unit to maintain the website. The application server should be scalable enough to handle a distributed data environment, and to be able to handle large loads of data, while being responsive to user requests. Preferably, the application server is a popular platform in which to build applications of tins type in order to support future changes, add-one, modifications, etc. The server preferably is an open architecture computer that has the ability for failed hardware parts to be replaced swiftly. This configuration also maintains the availability to increase the power of the machine. The platform for use in the system preferably has the ability to work with open database systems, provide a reliable and scalable platform for Internet and hue of business applications, and offer file and print services that give users easy and effective access to information and resources. The platform preferably integrates built-in networking and communication services into the underlying operating system infrastructure and also includes integrated and robust security services. The system of the present invention preferably uses a webserver that offers proven scalability and tight integration with the operating system and other products used in the system. The web server preferably includes publishing features, customizable tools, and technologies that permit the creation of Web pages, the publication of information to the World Wide Web, the sharing of files and data on commonly used operating systems, and the search capacity for content in different file types and multiple languages. Parties can be attracted to the system using conventional print, radio and television media, word of mouth, links on websites, partnerships with portals or web based companies, and/or through affinity program arrangements.

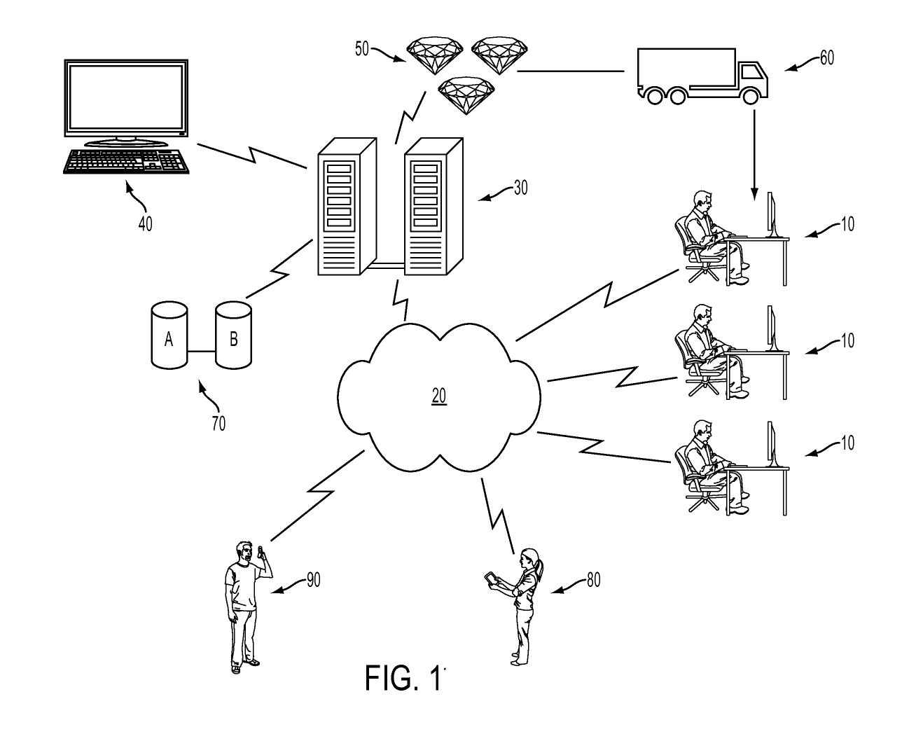

FIG. 1 shows how a person might use the automated system. At their personal computers (10) participants may connect to the auction system via the Internet (20). This connection leads to the system's central servers (30). The system's central servers are controlled by the system administrator from the administrator's computer interface (40). The central servers operate as a standalone system or may operate a cloud-based computing network regardless of the configuration, the auction system allows individual buyers to compete against each other in real time. When an auction is concluded successfully, the central servers enable the buyer and seller to complete the transaction electronically or in person. For example, if payment is processed electronically, the system may send a message for the physical delivery (60) of the acquired auction items (50) to the successful individual buyer. Buyers may also use mobile devices (80) or telephones (90) to connect to the system. The central server is also networked to a data storage facility (70) which stores all data relevant to the auctions and the transactions.

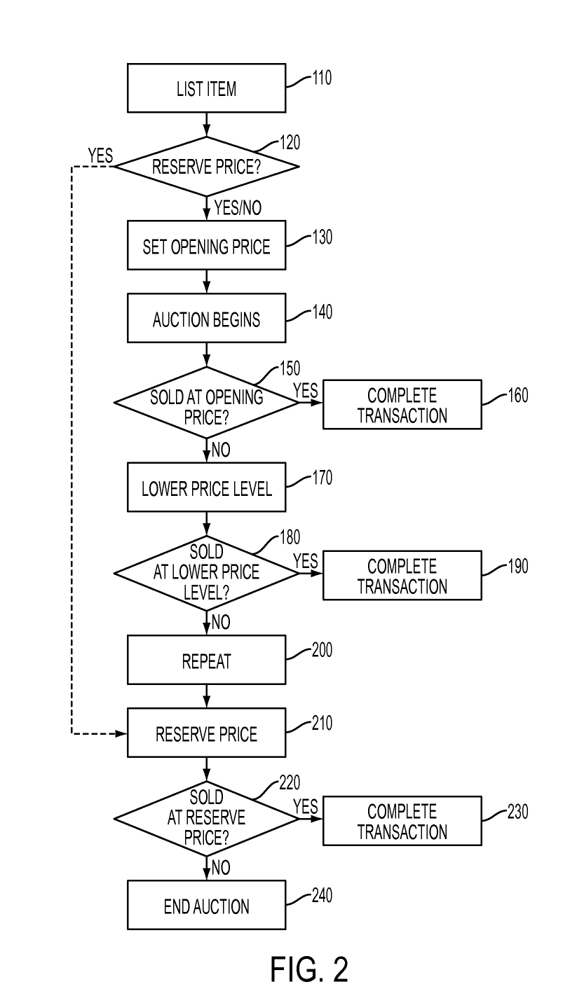

FIG. 2 shows a representative flow chart for the auction process. The auction system begins by listing the item for auction (110). The system administrator is prompted whether or not to list a reserve price (120). The system will proceed whether or not a reserve price is set. The system administrator must than set an opening price for the auction (130), a price reduction increment and a time interval. After the opening price has been set the auction begins (140). The system will then maintain the opening price for a period of time before asking whether the item has sold at the opening price (150). If the item sells at the opening price the system automatically moves to complete the transaction (160). If the item does not sell at the opening price then the system will lower the price level of the item (170). The system will then maintain the lower price level for the time interval before asking whether the item has sold at the opening price (180). If the item sells at the opening price the system automatically moves to complete the transaction (190). If the item does not sell at the opening price then the system will lower the price level of the item (200) in accordance with the price reduction increment, a step that may be repeated until the item hits the reserve price (210). If and when the item hits the reserve price the system will ask whether the item has sold at the reserve price (220), if it has, then the system will complete the transaction (230), if it has not sold at the reserve price, then the system will end the auction (240).

Another object of the invention is to provide a system of automated auctioning with at least one central processing unit comprising: (a) the central processing unit containing information corresponding to a sequential time-dependent series of rounds of offers to a plurality of parties to an auction; (b) an interface to a network connected to the central processing unit transmitting information corresponding to an acceptance of one of the offers in the series of rounds of offers by a party to the auction; (c) a server associated with the central processing unit which compares the information corresponding to the offer and the acceptance in accordance with preestablished conditions; (e) determining, using the server, if an agreement of the transaction is caused by an offer and an acceptance in a round by meeting the preestablished conditions; (f) a network connected to the central processing unit which also connects to a user interface which communicates if the offer and the acceptance in the round cause the agreement to all parties to the auction that the auction is concluded, or when none of the series of offers meets the preestablished conditions the network communicates that the auction is concluded at the end of the sequential time-dependent series of rounds of offers.

Another object of the invention is to provide a system and method comprising agreeing to an offer which, when applied by an auctioning system via a security protected online interface, will result in a transaction being carried out across a computer network involving transfer of ownership of an auctioned item to a party following and in return for a payment amount specified by the auction system across the computer network via a security protected online interface; the potential payment amount being determined according to values pre-selected prior to the beginning of the auction and receiving a notification of the payment amount for the transaction via the computer network. The system may either be set up to complete the transaction at that time via a standard online credit card or other currency transfer with automatically arranged delivery of the item; or the system may enable the private buyer to attend a physical inspection of the goods before consummating the purchase. Further provided is the system and method wherein, prior to receiving the acceptance of an offer, the method includes receiving a message via a computer network connected to a central processing unit that the current offer has not been accepted in which case the central processing unit will cause the auction system to lower the offer price. The system and method still further includes logging in to the auction system through the internet via an interactive user interface. The system and method may also include providing transaction specific identification information via the interactive user interface. Providing agent contact information for the transaction is also included in the system and method. The system and method further includes tabulating the transaction specific information. The system and method further includes accessing the auction system using a web browser. Also included in the method is submitting a plurality of items for auction to the auction system via an interactive computer network in which multiple user interfaces are connected to a central processing unit, the plurality of auctions being conducted simultaneously and capable of being participated in by the same user in real time. Still further provided is the system wherein the series of others to reach an agreement for the transaction comprise a set limit to the number of offers as specified by the central processing unit.

Another object of the invention is to provide a system and method comprising steps, stored in an automated auction system including a processor and data storage, for auctioning, the method comprising a step of executing a first program module via processor associated with a networked computer server, for offering prices via the internet to a plurality of parties, the values representing a time-dependent series of proposed amounts for which a transaction would be conducted for an auctioned item; a step for calculating using a processor a sequential series of time-dependent offer prices according to a specified formula using an individual proposed opening price level, which is submitted by an administrator using an interface networked with the processor, as an input for the specified formula for specifying a series of price offers for an auctioned item to be made while auctioning the item; a step of executing a program object, for sequentially offering the series of proposed amounts via the internet to the plurality of parties viewing the auction, in order to determine if an acceptance of one of the sequentially individual proposed amounts will be accepted by a party viewing the auction and for generating an agreement indication if an offer is accepted; and a step of executing a second program module for informing all parties to an auction that an offer has been accepted and a transaction has been completed for a calculated amount. The system and method still further includes a system administrator function via a secure interactive interface for logging-in a party prior to viewing the auction. The system and method further includes a step for collecting and processing transaction data using the processor. Finally, the system and method further includes a step for checking administration authorization to enable an administrator to add a party to the auction into the auction viewing system.

Another object of the invention is to provide a system and method comprising transmitting across a computer network a first signal representing a monetary offer for a transaction from a first entity; preparing the first signal for automated testing against an algorithm by an auctioning system in conjunction with acceptance of the offer from a second entity, the second entity being a party participating in an auction with respect to the transaction; receiving a response signal across the computer network indicating that the monetary offer of a particular amount caused an agreement condition in the auctioning system; forwarding a message including data representing an accepted offer amount, in response to the agreement condition, for ultimate delivery to the first entity; and where the agreement condition is not met, transmitting a second signal representing a monetary offer for a transaction from the first entity and repeating the steps of the method until an agreement condition is met or the monetary offer level falls to a pre-selected price point. The system and method further includes receiving signals including at least the information from the parties to the auction, the information having data representing acceptance of the monetary offer for the item auctioned in the transaction. Further provided is the system and method wherein the first entity is one of an entity to be paid, or a representative of the entity to be paid. The system and method further includes forwarding cookie data sent by the auctioning system tor storage on a hard drive or other storage device associated with the first entity usable by the auctioning system to track usage by the parties to the auction. Further included in the system and method is receiving further signals from the auctioning system for forwarding to a computer associated with the first entity which, when received, would cause the computer to retrieve the cookie data from the hard drive or other storage device and send it to the auctioning system.

The foregoing descriptions of specific embodiments of the present invention have been presented for purposes of illustration and description. They are not intended to be exhaustive or to limit the invention and method of use to the precise forms disclosed. Obviously many modifications and variations are possible in light of the above teachings. It is understood that various omissions or substitutions of equivalents are contemplated as circumstance may suggest or render expedient, but is intended to cover the application or implementation without departing from the spirit or scope of the claims of the present invention.

What is claimed is:

1. A computer executable method of conducting an auction, comprising:
receiving a request from one or more parties to enter an automated auction controlled by an auction administrator who controls the automated auctioning system;
entering details about a good received from a seller, including a reserve price, wherein the price level of the item to be auctioned cannot be lowered to be sold below the reserve price;
hosting the auction via a computer network which links one or more parties participating in the auction, to the automated auction system controlled by the auction administrator;
setting an opening price for an item to be auctioned;
displaying the opening price to the parties participating in the auction and beginning the auction by broadcasting via the computer network to the parties that auction bids at the opening price will be accepted;
setting a time interval after which the opening price for the item to be auctioned will be decreased to a new price level if it has not been sold;
setting a price increment by which the opening price for the item to be auctioned will be decreased to a new price level;
lowering the price of the item to be auctioned by the selected price increment to a new display price after the set interval has expired without a bid from the parties to the auction;
displaying the new display price to the parties participating in the auction and broadcasting via the computer network to the parties that auction bids at the new display price will be accepted;
administering the auction via the administrator to automatically repeat the step of lowering the display price of the item for auction by the selected price increment to a new price level after a selected time interval has expired, displaying the new price and broadcasting via the computer network to the parties that auction bids at the new price will be accepted;
accepting a bid for the item to be auctioned horn a party participating in the auction, or terminating the auction if a pre-determined reserve price has not been meet;
broadcasting across the computer network to the parties to the auction that the auction has been concluded;
concluding the auction.

2. The computer executable automated method of claim 1, wherein the auction administrator concludes the auction when a displayed price has been bid.

3. The computer executable automated method of claim 1, wherein the auction administrator concludes the auction if no bid has been received at a price level above the reserve price.

4. The computer executable automated method of claim 1, wherein the opening price is set by the seller of the item to be auctioned.

5. The computer executable automated method of claim 1, wherein the time interval after which the price level of an item to be auctioned will be decreased to a new price level is selected by the auction administrator.

6. The computer executable automated method of claim 1, wherein the price increment by winch the price level of an item to be auctioned will be decreased to a new price level is selected by the auction administrator.

7. The computer executable automated method of claim 1, wherein the functions performed by an auction administrator are performed by a third party seller of an item to be auctioned.

8. The computer executable automated method of claim 1, wherein the price increment is selected by the auction administrator in response to the number of participants participating in the auction.

9. The computer executable automated method of claim 1, wherein the time interval is selected by the auction administrator in response to the number of parties participating in the auction.

10. A system for an automated reverse auction carried out with a plurality of participants participating, comprising:
a server configured for conducting an auction for an item, and processing auction bids, wherein said server is also configured to lower an item price by a selected price increment to a new display price after a selected time interval has expired without a bid from the auction participants, to enable automatically repeating the step of lowering the display price of the item by the selected price increment to the new price level after a selected time interval has expired, to enable accepting a bid for the item from any of the participants, and to conclude the auction after acceptance of the bid for the item;
a data storage means networked to the server, wherein data related to the auction may be stored;
a computer interface, which enables an auction administrator to control the conduct of an auction, to set an opening price for an auctioned item, to set a time interval after which the opening price for the item to be auctioned will be lowered to a new price level, and to set a price increment by which the opening price for the item to be auctioned will be lowered to a new price level;
a graphical user interface that displays the opening price and new display prices to the auction participants, and permits the auction participants to place auction bids;
a computer network that connects participants in the auction to the auction administrator,
whereby the system conducts the auction by broadcasting auction information to the auction participants.

11. The system of claim 10, wherein said computer interface is configured to request a reserve price from the seller, wherein the price level of the auction item cannot be lowered below the reserve price and the auction is concluded if no bid has been received at a price level above the reserve price.

12. The system of claim 10, wherein said computer interface is configured to enable setting an opening price for an item to be auctioned by the auction administrator or a third party seller of the auction item.

13. The system of claim 10, wherein said computer interfaces configured to enable setting of a time interval after which the price level of an auction item will be decreased to a new price level, by the auction administrator or a third party seller of the auction item.

14. The system of claim 10, wherein said computer interfaces configured to enable setting of a price increment by which the price level of an item to be auctioned will be decreased to a new price level, by the auction administrator or a third party seller of the auction item.

15. The system of claim 10, wherein the computer network that enables a plurality of participants to join an auction, and a third party seller to access the computer interface and enter a reserve price, a price increment and a time interval perform the functions of an auction administrator.

16. The system of claim 10, wherein the computer network that enables a plurality of participants join an auction is the Internet.

17. The system of claim 10, wherein the server configured for conducting this auction is implemented and operated in a cloud-based computing network.

18. The system of claim 10, wherein the computer network further comprises connections that enable participants to join an auction via a wireless communication network.

19. The system of claim 10, wherein the graphical user interface provides participants access to the auction via a mobile electronic device.
